(19) United States
(12) Patent Application Publication
(10) Pub. No.: US 2008/0005861 A1
(43) Pub. Date: Jan. 10, 2008

(54) BRUSH BRISTLE MATERIAL AND BRUSH

(75) Inventors: Yuuichiro Niizaki, Chigasaki-shi (JP); Tomoko Niizaki, Chigasaki-shi (JP); Yunito Niizaki, Chigasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Yuuichiro Niizaki, Chigasaki-shi (JP); Tomoko Niizaki, Chigasaki-shi (JP)

(21) Appl. No.: 11/773,818

(22) Filed: Jul. 5, 2007

(30) Foreign Application Priority Data
Jul. 7, 2006 (JP) 2006-187371

(51) Int. Cl. A46D 1/00; B32B 15/00; B32B 3/10

(52) U.S. Cl. 15/207.2; 428/364; 428/378; 428/379; 428/397

(57) ABSTRACT

The brush bristle material of this invention has a synthetic resin material and a metallic material integrated into one or more pieces. The synthetic resin material and the metallic material mentioned above are made of nearly plate bar members and are integrated in the form of a plate or a bar or in any proper form by being mutually combined like a sandwich. The brush bristle material integrated by mutual combination of the component materials is enabled to combine the characteristic properties of the synthetic resin material and the metallic material and acquire proper hardness, elastic force and frictional force suited to a given workpiece, the shape of the workpiece and the purpose of use of the workpiece. This invention concerns a brush bristle material obtained by combining in a varying manner brush bristle materials made of raw materials differing in nature into one piece and enabled to produce a polish conforming to the hardness, shape and object of polishing of a workpiece and a brush manufactured of such brush bristle material.

### BACKGROUND OF THE INVENTION

1. Field of the Invention

This invention relates to a brush bristle material combining properties of both a synthetic resin material and a metallic material and to a brush. This invention more particularly relates to a brush bristle material produced by integrating brush bristle materials differing in character into one piece that enables a given workpiece to be ground in conformity with hardness, shape and purpose of grinding and ensures safe use by avoiding the accident of scattering even when the metallic brush bristle material is broken and to a bush.

2. Description of the Prior Art

The brush disclosed in JP-A 2003-164332 is produced by having a metallic line nipped among three metallic line materials and twisting them together. A metallic hollow pipe is inserted into the twisted part of the brush and fixed by subjecting the periphery of the brush to a drawing process.

Then, the brush disclosed in JP-A 2002-254277 is produced by having an aggregate yarn comprising a plurality of long alumina fibers hardened and bundled by being impregnated in a binder resin. The plurality of long alumina fibers mentioned above are such that the free ends thereof prevented from being hardened owing to the adhesion of the binder resin may be used for removing burrs, for example, by grinding.

The conventional brush bristle material, when endowed with increased strength, entails the possibility of sustaining breakage and consequently scattering fragments and giving rise to an accident. Since the workpieces requiring a grinding process are infinitely varied in hardness, softness, shape and the like, the desirability of developing brushes, the properties of which are capable of satisfying such variation, has been finding recognition. The conventional brush materials, however, are of excessive hardness, excessive softness, or an intermediate between such extremities. It has been difficult to obtain a brush that combines hardness and softness suitably for the purpose of use. Further, the conventional brush bristle materials have the possibility that the brush bristles will spread and prevent their distal end parts from touching a workpiece. For the purpose of preventing this mishap from taking place, the distal end parts are mutually combined with an adhesive agent. The adhesive agent used in the distal end parts is possibly caused to emit offensive odor by the heat generated in the course of grinding.

For the purpose of solving the problem mentioned above, this invention is aimed at providing a brush bristle material and a brush obtained by integrating a synthetic resin material and a metallic material and consequently enabled to combine the good points of the synthetic resin material and the metallic material. This invention is aimed at providing a brush bristle material and a brush obtained by uniting the synthetic resin material and the metallic material and consequently enabled to prevent an accident from taking place in consequence of sustaining breakage, endowed concurrently with strength and elastic force, and allowed to avoid emission of offensive odor, such as of the adhesive agent, owing to the heat of friction.

### SUMMARY OF THE INVENTION

The brush bristle material of the first aspect of the invention comprises a plate or bar member made of at least one synthetic resin material and a plate or bar member made of at least one metallic material, which members are mutually combined.

The brush bristle material of the second aspect of the invention comprises a plate or bar member made of at least one synthetic resin material having mixed therein one or more kinds of metallic abrasive grains and/or honing grains and a plate or bar member made of at least one metallic, which members are material mutually combined.

The brush bristle material of the third aspect of the invention comprises a plate or bar member made of at least one synthetic resin material and a plate or bar member made of at least one metallic material having mixed therein or being coated with 1% to 100% of one or more kinds of metallic abrasive grains and/or honing grains, which members are mutually combined.

The brush bristle material of the fourth aspect of the invention comprises a plate or bar member made of at least one synthetic resin material having mixed therein one or more kinds of metallic abrasive grains and/or honing grains and a plate or bar member made of at least one metallic material having mixed therein or being coated with 1% to 100% of one or more kinds of metallic abrasive grains and/or honing grains, which members are mutually combined.

The brush bristle material of the fifth aspect of the invention has a plurality of brush bristle materials set forth in any one of the first to fourth aspects of the invention bundled and the periphery of the bundle of brush bristle materials covered.

The brush bristle material of the sixth aspect of the invention has a plurality of different kinds of brush bristle materials set forth in any one of the first to fourth aspects of the invention bundled and the periphery of the bundle of brush bristle materials covered.

The brush bristle material of the seventh aspect of the invention has a plurality of the covered bundles set forth in the fifth or sixth aspect of the invention bundled into a large bundle and the periphery of the large bundle covered.

The brush bristle material of the eighth aspect of the invention has the brush bristle material set forth in any one of the first to seventh aspects of the invention formed in the shape of a line or bar having a polygonal section selected from among triangle, rectangle, hexagon, octagon, ellipse, cruciform, clover and the like.

The brush bristle material of the ninth invention has the abrasive grains set forth in any one of the second to eighth aspects of the invention include at least one kind of antistatic abrasive grains, flavor abrasive grains and deodorant abrasive grains.

The brush material of the tenth aspect of the invention has the brush bristles in the brush bristle material set forth in any one of the first to ninth aspects of the invention at least contain animal or plant brush bristle material.

The brush of the eleventh aspect of the invention has the brush bristle material set forth in any one of the first to tenth aspects of the invention finished as a channel brush, an implanted brush or a welded brush and destined to be used as a roll brush, a wheel brush, a coil brush, a tubular brush or a twisted brush.

This invention, by integrating a synthetic resin material and a metallic material, enables the produced brush bristle material to combine the characteristic properties of the synthetic resin material and the metallic material and acquire hardness, elastic force or frictional force expected to suit a workpiece, the shape of the workpiece or the purpose of use of the workpiece.

This invention, owing to the mutual union of a synthetic resin material and a metallic material, enables the produced brush bristle material to preclude the occurrence of an accident induced when the metallic material, while grinding a workpiece, is broken and scattered.

This invention produces the brush bristle material by mutually combining a synthetic resin material and a metallic material and consequently allows the part of the metallic material to suit grinding of a workpiece and permits the part of the synthetic resin material to acquire flexibility and further enables the brush bristle material, by being coated, to enhance the grinding property and adapt the strength and the elasticity for a given workpiece.

This invention is enabled to obtain a brush bristle material and a brush endowed with a wide range of grinding properties as by causing abrasive grains and/or honing grains in optionally varied kinds and/or quantities to be mixed with or applied as a coating to the synthetic resin material and the metallic material.

This invention allows combinations of varying kinds of the brush bristle materials to be further bundled. Then, the bundles of the brush bristle materials consequently obtained may be further bundled. Thus, this invention can produce a brush bristle material and a brush that are capable of performing a grinding process suited to the performance of a given workpiece.

Since this invention implements the integration of the synthetic resin material and the metallic material by means of thermo compression bonding or thermal welding instead of using an adhesive agent, the brush bristle material and the brush consequently produced are enabled to perform the work easily owing to the absence of the possibility that the heat generated during the course of grinding induces emission of offensive odor from the adhesive agent and inflicts stimulation to the worker's eyes.

The above and other objects, characteristic features and advantages of the present invention will become apparent to those skilled in the art from the description to be made herein below with reference to the accompanying drawings.

### BRIEF DESCRIPTION OF THE DRAWINGS

FIG. 1(a) through FIG. 1(j) represent Example 1 of this invention in perspective views each for illustrating one brush bristle material having a synthetic resin material and a metallic material mutually combined.

FIG. 2(a) through FIG. 2(d) represent Example 2 of this invention in cross sections each for illustrating abrasive grains mixed into a synthetic resin material.

FIG. 3(a) through FIG. 3(l) represent Example 3 of this invention in cross sections each for illustrating abrasive grains attached to the perimeter of a metallic material.

FIG. 4(a) through FIG. 4(c) represent Example 4 of this invention in perspective views and cross sections each for illustrating one brush bristle material having a plurality of brush bristle material bundled into one piece.

FIG. 5(a) through FIG. 5(d) represent Example 5 of this invention in perspective views each for illustrating one brush bristle material having a plurality of brush bristle materials integrated by covering.

FIG. 6(a) and FIG. 6(b) represent Example 6 of this invention in perspective views and cross sections each for illustrating one brush bristle material obtained by causing a plurality of brush bristle materials in an already covered state to be further covered.

FIG. 7(a) through FIG. 7(l) represent the cross sections for illustrating the shapes of the materials made of a synthetic resin material or a metallic material.

FIG. 8(a) through FIG. 8(c) represent a channel brush and an implanted brush manufactured of the brush bristle material conforming to this invention.

FIG. 9(a) through FIG. 9(h) represent views for illustrating brushes made of brush bristle material confirming to this invention.

### DETAILED DESCRIPTION OF THE PREFERRED EMBODIMENTS

The brush bristle material of the first aspect of the invention is formed at least solely by having a synthetic resin material and a metallic material mutually combined by means of thermo compression bonding or thermal welding, for example. The synthetic resin material or the metallic material constitutes substantially plate-shaped or bar-shaped members resembling sandwiched parts or adjacently disposed parts, which are mutually combined in the shape of a plate, a bar or other optional article. The brush bristle material that results from the combination mentioned above is enabled to acquire necessary hardness, elasticity and frictional force for fitting a workpiece, the shape of the workpiece or the use of the workpiece in consequence of the combination of the characteristics of the synthetic resin material and the metallic material. Then, the brush composed of the brush bristle materials is enabled by the synthetic resin material partaking in the mutual combination to preclude the occurrence of an accident that the metallic material will be broken and scattered while a given workpiece is being ground.

The synthetic resin material contains at least one member selected from the group consisting of polyamide-based resins, polypropylene, polyethylene, polyvinyl chloride, polyimides, polymers, polyesters, polyplastics, PEEK™ resin and aromatic polyamide-based heat-resistant fibers. The metallic material contains at least one member selected from the group consisting of iron, copper, piano wires, stainless steel, aluminum and alloys thereof.

The brush bristle material of the second aspect of the invention differs from that of the first aspect of the invention in having one or more kinds of metallic abrasive grains and/or honing grains mixed in the synthetic resin material. The brushes which are composed of the brush bristle materials allow numerous combinations, depending on the synthetic resin material, the metallic abrasive grains and/or honing grains, the mixing ratios thereof and the metallic material and possess an ability to acquire such hardness, elasticity, and frictional force as are required for the purpose of conforming to a given workpiece, the shape of the workpiece and the use of the workpiece and prevent the breakage of the metallic material as well. The synthetic resin material having mixed therein the aforementioned grains is obtained by mixing synthetic resin chips with the grains mentioned above or their powders, melting the resultant mixture at a prescribed temperature and forming the molten mixture in a prescribed shape with a metal mold or in a linear shape with a die.

The metallic abrasive grains and/or honing grains are formed of diamond, ceramics, glass, alumina, zirconia, silicon carbide, emery, CBN, GC, stainless steel, sand, volcanic ash, rare earth elements, charcoal or flavor grains. One or more kinds of such grains in an approximate amount of 1% to 50% are mixed with the synthetic resin material. Particularly, the brush bristle material containing the flavor grains effaces the offensive odor that is emitted when the brush bristle material is exposed to friction while grinding a workpiece.

The brush bristle material of the third aspect of the invention differs from that of the first aspect of the invention or that of the second aspect of the invention in having the metallic material coated on the periphery thereof with an optional amount of one or more kinds of metallic abrasive grains and/or honing grains. To be specific, in the brush bristle material, while the second aspect of the invention has the metallic abrasive grains and/or honing grains mixed in the synthetic resin material, the third aspect of the invention has the metallic material coated with the abrasive grains, etc. The brush bristle material has the metallic abrasive grains, etc. applied in the form of a coating to the periphery of the metallic material by means of electrodeposition, vapor deposition or plating. Since the amount (thickness) of the coating can be set arbitrarily, the metallic material is prevented from being broken by adapting the strength of nerve easily for the purpose or the shape and as well enabling the synthetic resin material to impart elastic force to the metallic material.

The metallic material has one or more kinds of abrasive grains and/or honing grains deposited in the form of a coating on the periphery thereof in a ratio of 1% to 100%. The coating in an approximate ratio of 1% to 10%, in a final analysis, is in the state in which the grains adhere to the periphery of the metallic material. One brush bristle material produced by combining a synthetic resin material and a metallic material renders the part of the metallic material suitable for grinding, vests the part of the synthetic resin material with flexibility and, in consequence of the coating on the periphery, enables the grindability or the strength of nerve to be further enhanced and facilitates adaptation of the grinding strength for a workpiece.

The synthetic resin material of the fourth aspect of the invention is produced by mixing the chips of synthetic resin obtained at the time of molding and one or more kinds of metallic abrasive grains and/or honing grains or powders thereof and forming the resultant mixture in the shape of a plate or bar member. Then, the metallic material of the present invention is in the form of a plate a bar member coated with one or more kinds of metallic abrasive grains and/or honing grains applied at a ratio of 1% to 100%. The synthetic resin material and the metallic material are mutually combined into one brush bristle member by means of thermo compression bonding or thermal welding.

The brush bristle material of the fifth aspect of the invention is formed at least solely by bundling a plurality of brush bristle materials set forth in the first to fourth aspects of the invention. These brush bristle materials are bundled by covering their collective periphery. This covering is secured with a cord or a net or covered on the joint circumference with a tubular body made of metal or synthetic resin. The covering that bundles the brush bristle materials may have the cord, net or tubular body mixed or coated with abrasive grains, antistatic grains, flavor grains, deodorant grains, metallic grains, etc.

The brush bristle material of the sixth aspect of the invention is formed at least solely by bundling a plurality of different kinds of brush bristle materials set forth in the first to fourth aspects of the invention and covering the collective periphery of the bundled brush bristle materials. The brush bristle materials of the fourth aspect of the invention and the fifth aspect of the invention are such that the different kinds mentioned above, the material used for mixing or coating, and the number constituting the plurality can be optionally decided so as to obtain the strength necessary for grinding a workpiece.

The brush bristle material of the seventh aspect of the invention is formed at least solely by having further bundled a plurality of the brush bristle materials of the fifth aspect of the invention. Then, the brush bristle material is formed at least solely by having a plurality of the brush bristle materials of the sixth aspect of the invention, namely different kinds of brush bristle materials, bundled. The brush bristle material mentioned above is bundled at least solely by covering the periphery thereof The brush bristle material is made of a synthetic resin material, a metallic material and animal and plant materials.

The brush bristle material of the eighth aspect of the invention has the synthetic resin member or the metallic member in the first through seventh aspects of the invention formed in the shape of a line or bar having a polygonal section selected from among triangle, rectangle, hexagon, octagon, ellipse, cruciform, cloverleaf and the like. The shape of the brush bristle material may be varied whenever necessary, depending on the kind, shape and use of a workpiece to be ground and the purpose of grinding.

The brush bristle material of the ninth aspect of the invention has the abrasive grins in the second through eighth aspects of the invention contain therein at least one kind of grains selected from the group consisting of antistatic grains, flavor grains and deodorant grains and is consequently enabled to prevent attachment of dirt to a workpiece and reduce the occurrence of offensive odor during the course of grinding as well.

The brush bristle material of the tenth aspect of the invention has the brush bristle in the first through ninth aspects of the invention contain therein at least a bristle made of an animal or a plant material. The brush bristle made of the animal or plant material, while grinding a workpiece, is capable of manifesting peculiar flexibility.

The brush of the eleventh aspect of the invention is finished as a channel brush, an implanted brush or a welded brush by causing the brush bristle material in the first through tenth aspects of the invention to be inserted in a channel member or embedded in a deck member and straightened up in appearance. Each of the brushes is formed in a proper shape capable of becoming at least one of brushes, such as roll brush, wheel brush, coil brush, tubular brush and twisted brush and acquiring the optimum shape, strength and elastic force for grinding a workpiece.

### EXAMPLE 1

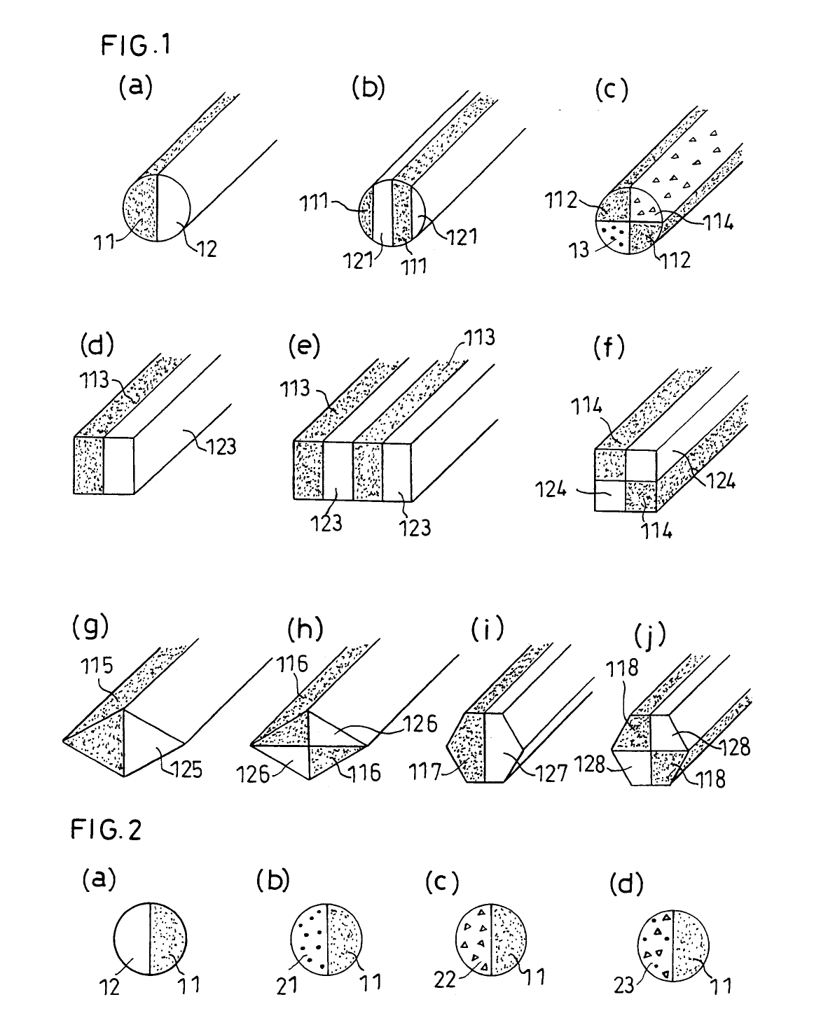

FIG. 1(a) through FIG. 1(j) depict Example 1 of this invention in perspective views each for illustrating one brush bristle material combining a synthetic resin material and a metallic material. The brush bristle material shown in FIG. 1(a) is in the form of one round bar body having a metallic material 11 and a synthetic resin material 12 integrated through mutual combination by thermo compression bonding or thermal welding. The brush bristle material shown in FIG. 1(b) is in the form of one round bar body having one synthetic resin material 121 interposed between two nearly plate metallic materials 111 and another disposed on the other side of metallic material 111 like a sandwich.

The brush bristle material shown in FIG. 1(c) is in the form of one round bar body consisting of two metallic materials 112 each possessing a cross section of one quarter of a circle, a synthetic resin material 13 similarly possessing a cross section of one quarter of a circle and containing abrasive grains in a mixed state therein and a synthetic resin material 114 similarly possessing a cross section of one quarter of a circle and containing diamond grains in a mixed state therein, with the metallic materials 112 interposed in a combined state between the synthetic resin material 13 and the synthetic resin material 114. The synthetic resin material 13, while it is being molded of resin chips in a proper shape, has diamond grains, metallic grains, rock grains, etc. or the powders thereof mixed therein.

The brush bristle material shown in FIG. 1(d) is in the form of one quadrate bar body having a metallic material 113 and a synthetic resin material 123, both in a rectangular or plate shape, mutually combined by thermo compression bonding or thermal welding. The brush bristle material shown in FIG. 1(e) is in the form of one quadrate plate body having one synthetic resin material 123 interposed between two nearly plate metallic materials 113 and another disposed on the other side of metallic material 113 like a sandwich. The brush bristle material shown in FIG. 1(f) is in the form of one quadrate bar body having two metallic material 114 possessing a cross section of one quarter of a square bar and two synthetic resin materials 124 similarly possessing a cross section of one quarter of a square bar alternately combined.

The brush bristle material shown in FIG. 1(g) is in the form of one rhomboid bar body having a metallic material 115 triangular in cross section and a synthetic resin material 125 similarly triangular in cross section mutually combined on one side each. The brush bristle material shown in FIG. 1(h) is in the form of one quadrate bar body having two synthetic resin materials 126 triangular in cross section and two metallic materials 116 similarly triangular in cross section mutually combined. The brush bristle material shown in FIG. 1(i) is in the form of one bar body polygonal in cross section having a metallic material 117 pentagonal in cross section and a synthetic resin material 127 nearly similar in cross section combined on the bottom part each.

The brush bristle material shown in FIG. 1(j) is in the form of one bar body polygonal in cross section having two metallic materials 118 trapezoidal in cross section and two synthetic resin materials 128 nearly similar in cross section mutually combined. The synthetic resin materials shown in FIG. 1(a) through FIG. 1(j) are made of at least one substance selected from among polyamide-based resins, polypropylene, polyethylene, polyvinyl chloride, polyimides, polymers, polyesters, polyplastics, PEEK™ resin, aromatic polyamide-based heat-resistant fibers. The metallic material is made of iron, copper, piano wires, stainless steel, titanium, aluminum, at least one of the alloys thereof or a varying kind of grains. Then, the synthetic resin material and the metallic material are integrated through combination, for example, by thermo compression bonding or thermal welding.

### EXAMPLE 2

FIG. 2(a) through FIG. 2(d) depict Example 2 of this invention in cross sections each for illustrating the mixture of abrasive grains in a synthetic resin material. The brush bristle material shown in FIG. 2(a) is in the form of a nearly circular bar body having a synthetic resin material 12 semicircular in cross section and a metallic material 11 similarly semicircular in cross section integrated through mutual combination. The brush bristle material shown in FIG. 2(b) is in the form having honing grains, abrasive grains, flavor grains or the like mixed in a synthetic resin material 21 semicircular in cross section. The grains to be mixed into the synthetic resin material are allowed to have the shape and the quality of material thereof so selected as to suit the purpose of grinding. The substances to be mixed in the synthetic resin materials 21 through 23 are allowed to have the kind of quality of material and/or the quantity thereof optionally selected as abrasive grains 21, diamond grains 22 and mixed grains 23 comprising abrasive grains and diamond grains as shown in FIG. 2(b) through FIG. 2(d), for example.

### EXAMPLE 3

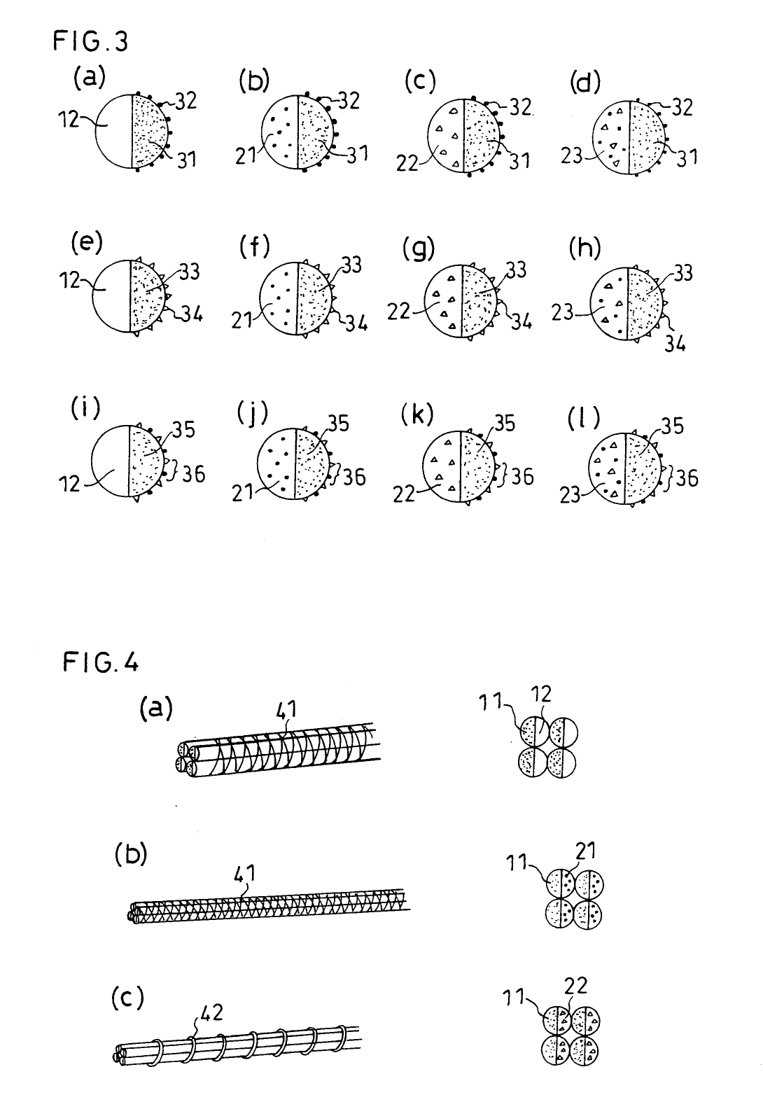

FIG. 3(a) through FIG. 3(l) depict Example 3 of this invention in cross sections each for illustrating the state in which abrasive grains are attached to the periphery of a metallic material. The brush bristle material shown in FIG. 3(a) is in the form having abrasive grains 32, for example, attached to the semicircular cross section of a metallic material 31 by electrodeposition, welding, plating or vapor deposition, for example. Then, the metallic material 31 has the surface thereof coated with the abrasive grains 32 as by plating. The coating can be applied in a uniform thickness to the metallic material 31, though not illustrated. The brush bristle material is in the form of one bar body having the metallic material 31 and the synthetic resin material 12 integrated through mutual combination similarly to the brush bristle material of FIG. 2. The brush bristle material shown in FIG. 3(b) is in the form of one bar body having a synthetic resin material 21 containing abrasive grains therein in a mixed state and a metallic material 31 holding abrasive grains 32 thereon in an attached state integrated through mutual combination.

The brush bristle materials shown in FIG. 3(c) and FIG. 3(d) are sole bar bodies having synthetic resin materials 22 and 23 containing diamond abrasive grains and/or abrasive grains therein in a mixed state and a metallic material 31 holding abrasive grains 32 thereon in an attached state respectively integrated through mutual combination. The brush bristle materials shown in FIG. 3(e) through FIG. 3(h) are sole bar bodies having a synthetic resin material 12, synthetic resin materials 21 through 23 containing diamond abrasive grains and/or abrasive grains in a mixed state, and a metallic material 33 holding diamond grains 34 etc. thereon in an attached state respectively integrated through mutual combination. The brush bristle materials shown in FIG. 3(i) through FIG. 3(l) are sole bar bodies having a synthetic resin material 12, synthetic resin materials 21 through 23 containing diamond abrasive grains and/or abrasive grains therein in a mixed state, and a metallic material 35 holding abrasive grains and/or diamond abrasive grains 36 etc. thereon in an attached state respectively integrated through mutual combination.

Examples 2 and 3 shown in FIG. 2 and FIG. 3 can be realized as brush bristle materials that suit with the raw material, hardness, elastic force, shape and purpose of grinding of a workpiece by selecting the combinations of synthetic resin materials and metallic materials and mixing or attachment of abrasive grains and/or diamond abrasive grains.

### EXAMPLE 4

FIG. 4(a) through FIG. 4(c) are pairs each of a perspective view and a cross section severally illustrating one brush bristle material having a plurality of brush bristle materials bundled into one piece. The brush bristle material shown in FIG. 4(a) has bundled into one piece four brush bristle materials each having a metallic material 11 and a synthetic resin material 12 mutually combined as shown in FIG. 1(a). The brush bristle material is covered with a cord or net made of synthetic resin or metal. The brush bristle materials shown in FIG. 4(b) and FIG. 4(c) can be each produced as one brush bristle material having a plurality of brush bristle materials shown in FIG. 2 and FIG. 3 bundled.

### EXAMPLE 5

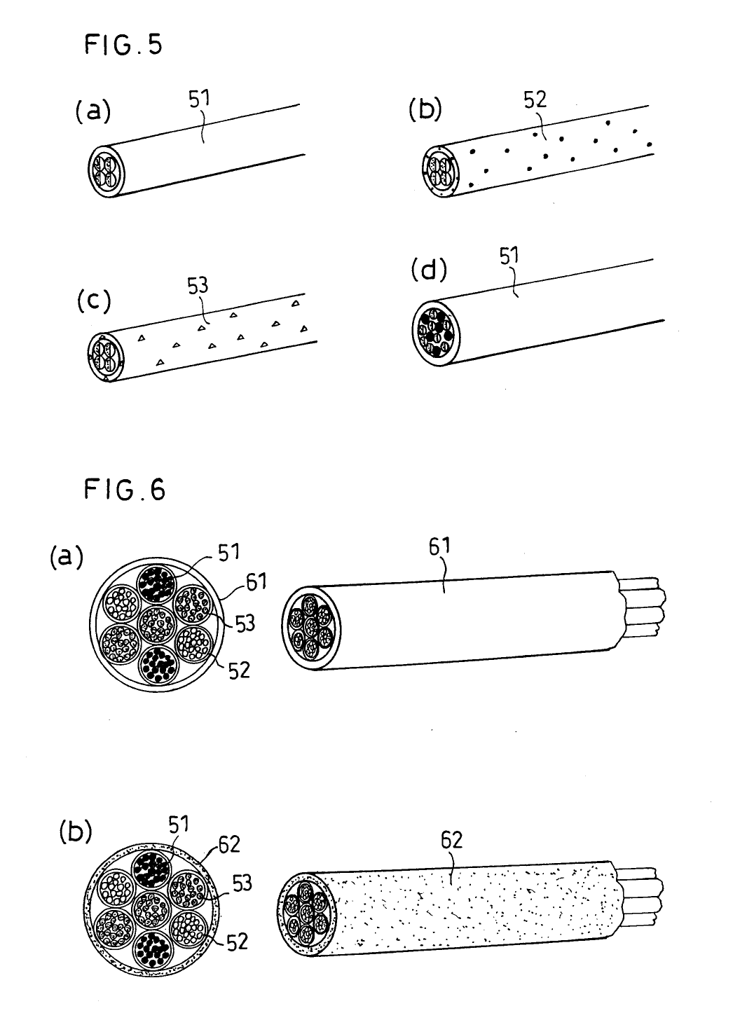

FIG. 5(a) through FIG. 5(d) are perspective views each illustrating one brush bristle material produced by collectively covering a plurality of brush bristle materials. The brush bristle material shown in FIG. 5(a) has brush bristle materials shown in FIG. 2 and FIG. 3 collectively inserted in a pipe material 51 made of synthetic resin or the like. The brush bristle materials shown in FIG. 5(b) and 5(c) have abrasive grains, diamond abrasive grains or the like mixed into pipe materials 52 and 53 made of the synthetic resin mentioned above or the like. The brush bristle material shown in FIG. 5(d) has different kinds of brush bristle material inserted into the pipe material 51 mentioned above. The pipe material may be made of metal. The pipe made of synthetic resin allows abrasive grains, diamond abrasive grains or powders thereof to be mixed into the synthetic resin while the synthetic resin is in the process of manufacture. The pipe material made of metal allows abrasive grains or diamond abrasive grains to be attached thereto or applied thereto in the form of a coating through electrodeposition, welding, plating or the like.

### EXAMPLE 6

FIG. 6(a) and FIG. 6(b) are pairs each of a perspective view and a cross section illustrating one brush bristle material obtained by covering a plurality of already covered brush bristle materials. The brush bristle material shown in FIG. 6(a) is what is obtained by causing the plurality of brush bristle materials 51 through 53 shown in FIG. 5 severally bundled already with coverings (pipe materials made of metal and synthetic resin) to be further bundled with another covering 61. The brush bristle material shown in FIG. 6(b) differs from that shown in FIG. 6(a) in having abrasive grains mixed in the covering 62.

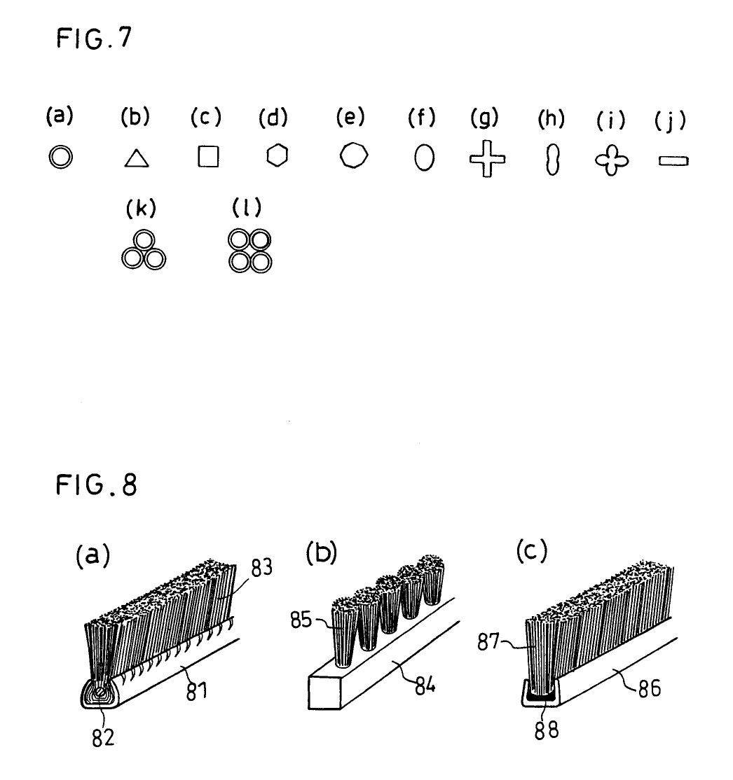

FIG. 7(a) through FIG. 7(l) are intended to explain the shapes of the materials contemplated by this invention. These materials are of synthetic resin and metal. The materials shown in FIG. 7 are enabled in an either single or combined form to assume such sectional shapes as belong to examples. FIG. 8 depicts examples of channel brush and implanted brush manufactured of brush bristle material of this invention. The brush shown in FIG. 8(a) is a channel brush obtained by halving a brush bristle material with a core line 82 placed along the center thereof and embedding the halved brush bristle material into a channel 81. The brush shown in FIG. 8(b) has a brush bristle material 85 embedded in a deck 84. The brush shown in FIG. 8(c) has a brush bristle material 87 embedded in a channel 86 after the material 87 has the central part thereof fixed with an adhesive agent 88.

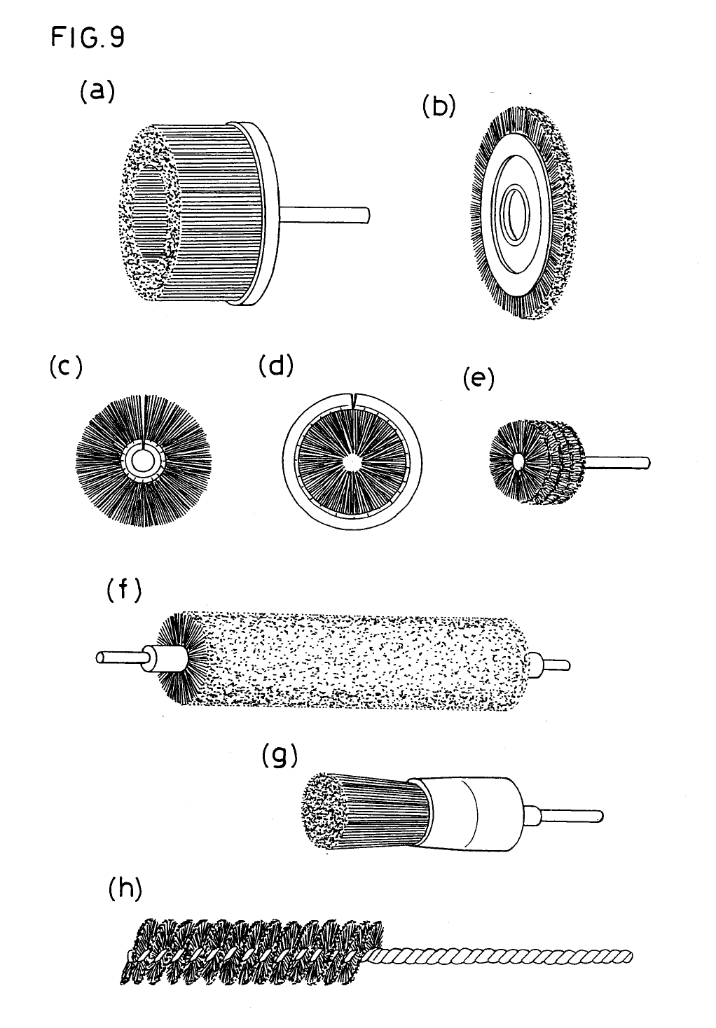

FIG. 9(a) through FIG. 9(h) are intended to explain the brushes manufactured of the brush bristle materials of this invention. FIG. 9(a) represents a cup brush, FIG. 9(b) a disc brush having a channel brush attached to the perimeter of a disc, FIG. 9(c) a disc brush having a channel brush bent into a circle, FIG. 9(d) a brush manufactured by causing a brush bristle material attached to a channel to be bent as directed toward the inner side, FIG. 9(e) and FIG. 9(f) each represent a roll brush, FIG. 9(g) a tubular brush and FIG. 9(h) a twisted brush. These brushes are manufactured based on the brush bristle materials that conform to the examples of this invention.

This invention has been described in detail by reference to the examples thereof This invention, however, is not limited to these examples. It allows various changes of design without departure from the component matters of the scope of claim for patent. The brush bristles and the substances to be mixed therein may be optionally selected in terms of quality of material, size, shape, density and the like. As regards the metallic material, synthetic resin material and material to be mixed, it is only natural that not only those cited in the present specification but also those publicly known or universally known can be used.

What is claimed is:

1. A brush bristle material comprising a plate or bar member made of at least one synthetic resin material and a plate or bar member made of at least one metallic material which members are integrated into one piece.

2. A brush bristle material comprising a plate or bar member made of at least one synthetic resin material having mixed therein one or more kinds of metallic abrasive grains and/or honing grains and a plate or bar member made of at least one metallic material, which members are integrated into one piece.

3. A brush bristle material comprising a plate or bar member made of at least one synthetic resin material and a plate or bar member made of at least one metallic material having mixed therein or being coated with 1% to 100% of one or more kinds of metallic abrasive grains and/or honing grains, which members are integrated into one piece.

4. A brush bristle material comprising a plate or bar member made of at least one synthetic resin material having mixed therein one or more kinds of metallic abrasive grains and/or honing grains and a plate or bar member made of at least one metallic material having mixed therein or being coated with 1% to 100% of one or more kinds of metallic abrasive grains and/or honing grains, which members are integrated into one piece.

5. A brush bristle material according to any one of claim 1 to claim 4, wherein it has a plurality of said brush bristle materials bundled into a bundle and wherein the bundle has a periphery covered.

6. A brush bristle material according to any one of claim 1 to claim 4, wherein it has a plurality of different kinds of brush bristle materials bundled into a bundle and wherein the bundle has a periphery covered.

7. A brush bristle material according to claim 5. wherein the covered bundle comprises a plurality of covered bundles bundled into a large bundle and the large bundle has a periphery covered.

8. A brush bristle material according to claim 6, wherein the covered bundle comprises a plurality of bundles bundled into a large bundle and the large bundle has a periphery covered.

9. A brush bristle material according to claim 1, wherein the brush bristle material is formed in a shape of a line or bar having a polygonal cross section selected from among triangle, rectangle, hexagon, octagon, ellipse, cruciform and cloverleaf.

10. A brush bristle material according to claim 2, wherein the abrasive grains include at least one kind of antistatic abrasive grains, flavor abrasive grains and deodorant abrasive gains.

11. A brush bristle material according to claim 1, wherein the brush bristle material at least contains an animal or plant brush bristle material.

12. A brush according to claim 1, wherein the brush bristle material is finished as a channel brush, an implanted brush or a welded brush and is destined to be used as a roll brush, a wheel brush, a coil brush, a tubular brush or a twisted brush.
